(19) United States
(12) Patent Application Publication
(10) Pub. No.: US 2026/0130329 A1
(43) Pub. Date: May 14, 2026

(54) Dynamic Fluid Application Controller

(71) Applicant: Reinke Manufacturing Company, Inc., Deshler, NE (US)

(72) Inventors: Douglas Lynn WILKINSON, Belleville, KS (US); Russell Scott REINKE, Deshler, NE (US)

(21) Appl. No.: 18/940,628

(22) Filed: Nov. 7, 2024

(51) Int. Cl. A01G 25/16

(52) U.S. Cl. CPC A01G 25/165

(57) ABSTRACT

A dynamic fluid application controller and systems incorporating the same are provided to optimize liquid application. The controller uses real-time environmental data such as weather conditions, vegetation height, growth stage, and sprinkler performance to determine irrigation strategies. The system integrates sensors and a vision system to compare the intended liquid application rate with actual amounts of liquid applied to a target area. Adjustments are made in real time to compensate for variables like drift, evaporation, and clogs. In some embodiments, the controller can either autonomously control irrigation or provide operational recommendations to an operator, and track observed liquid application performance to support data-driven decisions that improve crop health and yield.

### TECHNICAL FIELD

The present disclosure generally relates to irrigation equipment and, more particularly, to a control system used to improve fluid application to a field or other soil substrate.

### BACKGROUND

The following discussion of the background of the disclosure is intended to facilitate an understanding of the present disclosure. However, it should be appreciated that the discussion acknowledgment or admission that any of the referenced material was published, known, or part of the common general knowledge as of the priority date of the application. Some embodiments of the disclosure are described herein with reference to irrigation equipment, machines and/or systems. However, it will be understood and appreciated by those having ordinary skill in the art that embodiments of the disclosure are not limited to irrigation system applications and may be used in other applications where optimizing liquid distribution within a bounded area would be beneficial.

Irrigation systems enable users to manage water resources and, in some instances, other liquids. The primary purpose of these systems is to enable the application of an optimal amount of water at critical times during a plant’s life cycle. In commercial and subsistent agriculture, proper watering fortifies crop health and maximizes yield potential; in residential applications, proper watering promotes health and appearance of a landscape. Irrigation systems may be relatively larger scale, such as a mechanized irrigation system used to water large fields that includes a mechanical structure, a drivetrain, and a control system managing water output. Irrigation systems may alternatively take the form of single aboveground sprinklers or in-ground sprinkler systems used in residential settings.

### SUMMARY

One common problem with irrigation systems of any scale is proper and uniform fluid application. Non-uniform water distribution results in some areas receiving too much water, which can cause root rot, leaching of nutrients, and other negative effects. On the other hand, areas receiving insufficient water experience drought stress, leading to stunted growth, reduced yields, or even plant death. Variability in growth impacts overall crop productivity and quality. When water is applied unevenly, excess water in some areas leads to runoff and infiltration beyond the root zone, wasting valuable resources. This is particularly problematic in regions facing water scarcity or restrictions on water use. Systems that do not deliver water uniformly require more frequent adjustments and maintenance to compensate for deficiencies in coverage. Farmers and landscapers may overcompensate by using more water, increasing energy consumption for pumps and contributing to higher operational costs. Over-application of water in some areas can cause soil erosion, particularly on sloped terrain. This eroded soil can then accumulate in low-lying areas, further exacerbating water distribution issues and reducing the effectiveness of the irrigation system. Non-uniform watering can also lead to uneven distribution of fertilizers and chemicals applied through irrigation systems. Overwatered areas may experience nutrient leaching, while under-watered areas fail to receive the proper nutrient or chemical application, affecting overall crop health and yield.

Non-uniform water distribution can have many different causes, including pressure variations caused by pressure drops, changes in terrain, soil type, and plant density, incorrect or inefficient sprinkler spacing, nozzle wear, environmental factors (e.g., wind, evaporation), clogs, blockages, and the like. One significant cause of non-uniform and inefficient water distribution is human error; whether a homeowner that activates their in-ground sprinkler system on a fixed schedule with no regard for environmental factors or a farmer that turns on their pivot irrigation system because they saw other pivot systems energized on their way to a field, the usual way of controlling frequency and duration of water distribution is for an operator to utilize timers, duty cycles, and intuition. The actual amount soil moisture level, which is the most consequential effect of water application, is unlikely to be factored, let alone uniform, across a soil substrate.

Unlike conventional irrigation and liquid application strategies, and to achieve more uniform application of fluids to vegetation and soil substrates, the present disclosure is directed to systems and methods for dynamically controlling the application of a fluid to vegetation and soil substrates. A dynamic fluid application controller utilizes integrated sensors to determine how much liquid is supplied to a sprinkler or other liquid-emitting component. Under ideal conditions, the amount of applied liquid would be equal to an input or command with a target fluid application rate (i.e., if an irrigation system was run to apply one inch of water, then one inch of water would reach the substrate). However, due to numerous different factors such as drift, evaporation, clogs in irrigation systems, variable water supply pressures, terrain, the amount of fluid actually applied to vegetation or the soil is typically different than what is intended to be applied to the vegetation or soil. In order to apply the full target application rate, optical sensors are used to observe or determine the amount of fluid that has been applied to a target area and feedback to the control system to continue applying fluid until the target application rate is achieved. External sensors, such as soil moisture sensors, can be used to train a machine-learned model that can increase the accuracy of the optical sensors and attribute differences in the amount of liquid emitted by a sprinkler and applied fluid to one or more independent factors, such as weather conditions.

Accordingly, aspects of the present disclosure are directed to an irrigation system. The system comprises a sprinkler configured to apply a fluid to a soil substrate. The system further comprises a valve for regulating a fluid supply to the sprinkler. The system further comprises one or more computer processing components. The system further comprises a non-transitory computer readable media with computer-executable instructions stored thereon that, when executed by the one or more computer processing components, cause the one or more computer processing components to perform operations. The operations comprise determining a first fluid application target rate for a first area and a second fluid application target rate for a second area, the first fluid application target rate being different than the second fluid application target rate. The operations further comprise determining a first amount of applied fluid at the first area and a second amount of applied fluid at the second area. The operations further comprise, based on a determination that the first amount of applied fluid at the first area is greater than the first fluid application target rate, causing the sprinkler to stop applying the fluid in the first area. The operations further comprise, based on a determination that the second amount of applied fluid at the second area is less than the second fluid application target rate, causing the sprinkler to continue applying the fluid in the second area until the second amount of realized fluid application at the second area is greater than the second fluid application target rate.

Other aspects of the present disclosure are directed to a method for controlling operation of a liquid emitting component. The method comprises receiving a target liquid application instruction for a target area. The method further comprises determining a target amount of a liquid to be applied to the target area by the liquid emitting component in order to achieve the target liquid application instruction. The method further comprises determining an amount of time to supply the liquid to the liquid emitting component in order for the liquid emitting component to emit the target amount of the liquid. The method further comprises causing the liquid to be supplied to the liquid emitting component for the amount of time. The method further comprises receiving, during the amount of time wherein liquid is supplied to the liquid emitting component, feedback from one or more sensors that indicates how much of the target amount of the liquid has been applied to the target area.

Yet other aspects of the present disclosure are directed to a non-transitory computer readable having computer-executable instructions stored thereon that, when executed by one or more computer processing components, cause the one or more computer processing components to perform a method for controlling operation of a liquid emitting component. The method comprises receiving a target liquid application instruction for a target area. The method further comprises determining a target amount of a liquid to be applied to the target area by the liquid emitting component in order to achieve the target liquid application instruction. The method further comprises determining an amount of time to supply the liquid to the liquid emitting component in order for the liquid emitting component to emit the target amount of the liquid. The method further comprises causing the liquid to be supplied to the liquid emitting component for the amount of time. The method further comprises receiving, during the amount of time wherein liquid is supplied to the liquid emitting component, feedback from one or more sensors that indicates how much of the target amount of the liquid has been applied to the target area.

Yet other aspects of the present disclosure are directed to a method for controlling operation of a liquid emitting component. The method comprises generating a grow plan for a target area, the grow plan comprising a target moisture level for the target area based on one or more of soil type, crop type, and grow season. The method further comprises determining that a current moisture level for the target area is at least a predetermined threshold less than the target moisture level. The method further comprises generating a proposed liquid application plan comprising an amount of liquid to be applied to the target area in order to achieve the target moisture levels stipulated in the grow plan based on historical liquid application data. The method further comprises causing the amount of liquid to be applied to the target area without intervention or external instructions from an operator.

Yet other aspects of the present disclosure are directed to a non-transitory computer readable having computer-executable instructions stored thereon that, when executed by one or more computer processing components, cause the one or more computer processing components to perform a method for controlling operation of a liquid emitting component. The method comprises generating a grow plan for a target area, the grow plan comprising a target moisture level for the target area based on one or more of soil type, crop type, and grow season. The method further comprises determining that a current moisture level for the target area is at least a predetermined threshold less than the target moisture level. The method further comprises generating a proposed liquid application plan comprising an amount of liquid to be applied to the target area in order to achieve the target moisture levels stipulated in the grow plan based on historical liquid application data. The method further comprises causing the amount of liquid to be applied to the target area without intervention or external instructions from an operator.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts a front elevation view of a section of an irrigation system, in accordance with aspects hereof;

FIG. 2 illustrates an environment comprising an irrigation system comprising one or more dynamic fluid application controllers, in accordance with aspects of the present disclosure;

FIG. 3 illustrates another environment comprising an irrigation system comprising one or more dynamic fluid application controllers, in accordance with aspects of the present disclosure;

FIG. 4 is a simplified block diagram of the dynamic fluid application controller of FIGS. 2-3, in accordance with aspects of the present disclosure;

FIG. 5 depicts a flow diagram illustrating a method of controlling fluid application to a soil substrate, in accordance with aspects of the present disclosure; and

FIG. 6 depicts a flow diagram illustrating a method of controlling irrigation system activation, in accordance with aspects of the present disclosure.

### DETAILED DESCRIPTION

Various modifications and different embodiments will be described below in detail with reference to the accompanying drawings so that those skilled in the art can carry out the disclosure. It should be understood, however, that the present disclosure is not intended to be limited to the specific embodiments, but the present disclosure includes modifications, equivalents or replacements that fall within the spirit and scope of the disclosure as defined in the following claims. The terminology used herein is for the purpose of describing specific embodiments only and is not intended to limit the scope of the disclosure.

As used herein, the singular forms "a", "an" and "the" are intended to include the plural forms as well, unless the context clearly indicates otherwise. In the disclosure, terms such as "comprises", "includes", or "have/has" should be construed as designating that there are such features, integers, steps, operations, components, parts, and/or combinations thereof, not to exclude the presence or possibility of adding of one or more of other features, integers, steps, operations, components, parts, and/or combinations thereof.

In addition, aspects hereof may be described using relative location terminology. For example, the term “proximate” is intended to mean on, about, near, by, next to, at, and the like. The term “about” when used in relation to measurements means within ± 10% of a designated value. Therefore, when a feature is proximate another feature, it is close in proximity but not necessarily exactly at the described location or in abutting contact, in some aspects. Additionally, the term “distal” refers to a portion of a feature herein that is positioned away from a midpoint of the feature. Terms such as “coupled,” “attached,” “fastened,” “secured,” “affixed,” and the like may mean elements that are releasably attached or connected to one another using, for example, bolts and the like. These terms may further mean elements that are permanently attached to one another using, for example, rivets, welding, and the like.

The term “releasable fastener” as used herein refers to a fastener system that can be repeatedly, selectively, coupled and uncoupled to respectively secure or disengage components from each other. In line with this, the term “complementary” when describing components of a releasable fastener system means components having structures that mechanically engage with each other (e.g., a nut and a bolt may mechanically engage one another at threads formed thereon).

The term “end” when used in relation to the end of a pipeline, rail, or truss rod may mean a terminal edge of said component. Such term may also mean a portion of the pipeline, rail, or truss rod within about 12 inches of the terminal edge of said component. The term “about” when used in relation to measurements means within ± 10% of a designated value. The terms “axial direction” and “longitudinal direction” are used interchangeably herein and mean the direction the pipeline, rail, or truss rod extends from a first end of said component to a second end of said component. The term “substantially” when used in relation to positional descriptions means primarily.

At a high level, aspects herein are directed to a dynamic fluid application controller and irrigation systems comprising the dynamic fluid application controller. The dynamic fluid application controller utilizes one or more internal and external inputs in order to improve the uniformity of fluid application to a soil substrate, by way of effecting changes in one or more of frequency, duration, and directivity of an applied fluid.

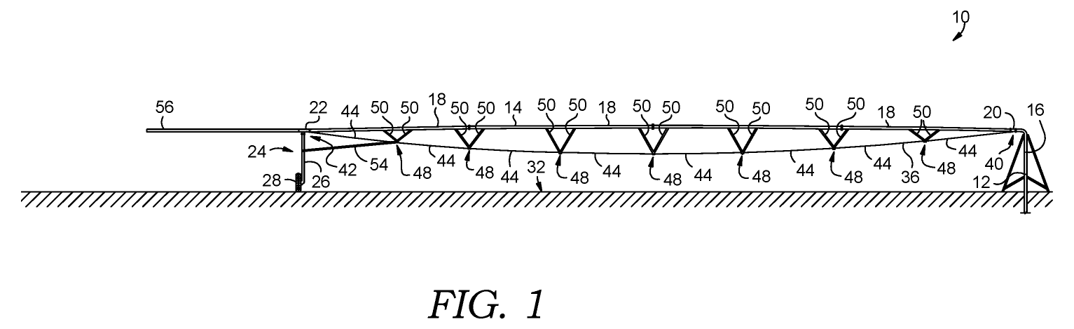

Referring now initially to FIG. 1, an aspect of an irrigation system 10 is illustrated. The illustrated irrigation system 10 is a segment of a center-pivot type irrigation system that revolves or rotates around a fluid source 12. In other aspects, however, the irrigation system may be a linear or lateral move irrigation system, or any other type of irrigation system. The illustrated irrigation system 10 includes a pipeline 14 coupled to the fluid source 12. The pipeline 14 extends from the fluid source 12 to a tower 24. In other aspects, however, the irrigation system 10 may include a plurality of spans, each including a pipeline 14 and a tower 24. Regardless of the number of spans the irrigation system 10 is composed of, the pipeline 14 may comprise a plurality of pipe segments 18 coupled to one another. In other words, each span of the irrigation system 10 may include multiple pipe segments joined together to communicate irrigation fluid there through.

A first segment 20 of the pipeline 14 may connect to the fluid source 12 with a span coupling. The first segment 20 may include the span coupling, or a portion of the span coupling (e.g., a hook), for detachably coupling to the fluid source 12. The span coupling may comprise a hook and receiver type span coupling. For example, the first segment 20 may include a hook that may be detachably coupled to a receiver (e.g., a ring) connected to the fluid source 12. Such a span coupling may provide a highly efficient point of rotation for the pipeline 14 when placed in the center of the pipeline 14.

It may be advantageous in some aspects to provide a multi-span irrigation system to permit irrigation of a greater area. For example, the irrigation system 10 may comprise a first span, a second span, and an ancillary irrigation span. The tower 24 supports the last segment 22 of the pipeline 14, for example by supporting an intermediate portion of the pipeline 14 resulting in an end portion 56 of the pipeline 14 cantilevered past the tower 24. The tower 24 includes one or more support legs 26 and one or more wheels 28. In some aspects, the tower 24 is self-propelled and includes a drive unit that causes the wheels to rotate to carry the pipeline 14 over a field-of-interest or irrigation coverage area such as a crops field. In other aspects, other equipment (e.g., electronics) may be mounted on the tower 24.

The irrigation system 10 comprises a truss system. A first end 40 of a truss rail 36 is coupled to the first segment 20 of the pipeline 14. Likewise, a second end 42 of the first truss rail 36 is coupled to the last segment 22 of the pipeline 14. The first truss rail 36 includes a plurality of headed truss rods 44 coupled end-to-end between a pair of cooperating mating members at each of one or more intermediate joints 48. The truss system includes a plurality of pairs of struts 50 extending from the pipeline 14 with which they are coupled via conventional means (e.g., fastened to a plate that is welded to the pipeline 14). Each pair of struts 50 additionally is coupled to each other at one of the intermediate joints 48. In the illustrated embodiment, a brace 54 also extends from the tower 24 to one of the intermediate joints 48 to provide additional support and to stabilize the tower 24.

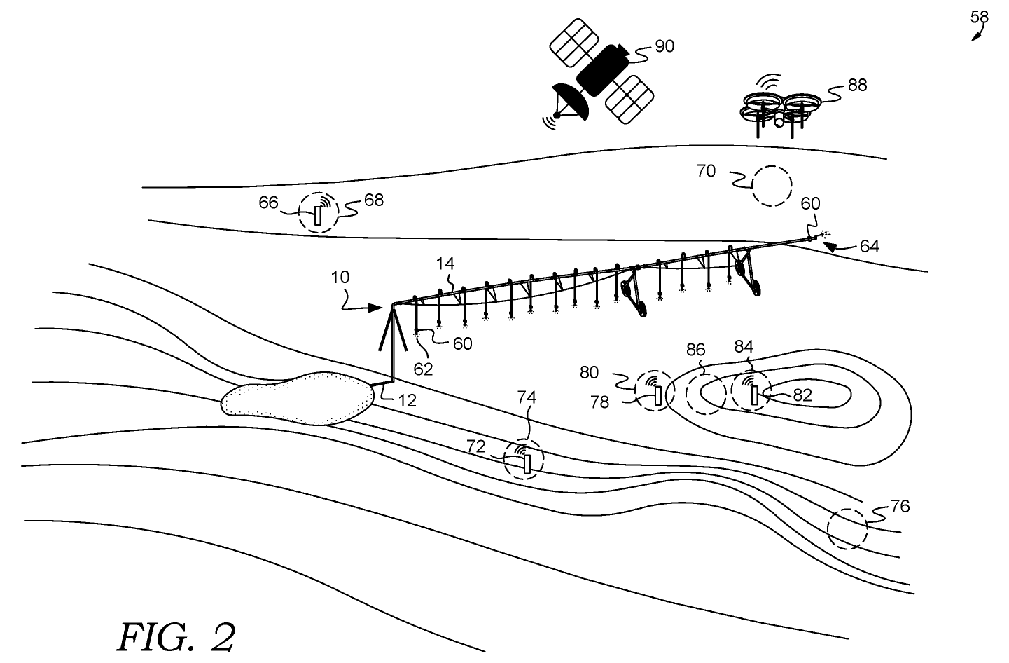

Turning now to FIG. 2, an environment 58 is illustrated comprising an irrigation at least partially implemented with a dynamic fluid application controller in accordance with aspects of the present disclosure. The environment 58 comprises an irrigation system, such as the irrigation system 10 of FIG. 1, at least one dynamic fluid application controller 60, at least one fluid application component, and at least one external sensor. The environment 58 is for illustrative purposes; it is expressly conceived that the environment 58 could be implemented with irrigation systems of differing forms or scale. The environment 58 comprises a field with a soil substrate, illustrated using a topographical form, wherein contour lines indicate a common elevation. The irrigation system 10 is utilized to provide moisture to the soil substrate of the environment 58, particularly between natural precipitation events. Several factors can affect the moisture level of a soil substrate; elevation changes affect runoff/pooling, crop densities affect moisture absorption from the soil substrate, and variable environmental factors (e.g., precipitation, wind drift, and evaporation) affect how much moisture is received, absorbed, and retained by the soil substrate. Ideally, the irrigation system 10 would be utilized to provide a more or less uniform moisture to the soil substrate of the environment 58; however, because soil substrate moisture levels can be highly variable when activating the irrigation system 10, it is all but guaranteed that conventional watering result in non-uniform soil moisture levels – leaving some areas too wet and prone to rot, while other areas might continue to be too dry.

The environment 58 comprises at least one dynamic fluid application controller 60. In aspects, the dynamic fluid application controller 60 is configured to control the amount of fluid expelled by a fluid application component, such as by a rotating sprinkler 62. In other aspects, the dynamic fluid application controller 60 is configured to control both the amount of fluid expelled by the fluid application component and the orientation of the fluid application component. For example, a precision sprinkler 64 comprising a multi-axis mount may be controlled by the dynamic fluid application controller 60 to emit a narrow stream of fluid in a particular orientation in order to apply the fluid to a specific point on the soil substrate.

The environment 58 comprises one or more external sensors that are used by the dynamic fluid application controller 60 in order to validate integrated sensor data, make irrigation activation decisions/recommendations, and ensure more uniform fluid application rates by the irrigation system 10. In one aspect, the one or more external sensors comprise wireless soil moisture sensors, such as the first soil sensor 66, the second soil sensor 72, the third soil sensor 78, and the fourth soil sensor 82. The first soil sensor 66 is located in and associated with a first area 68, the second soil sensor 72 is located in and associated with a second area 74, the third soil sensor 78 is located in and associated with a third area 80, and the fourth soil sensor 82 is located in and associated with a fourth area 84. Each of the one or more soil sensors comprise a wireless communication interface, configured to facilitate wireless communication between the soil sensor and a receiving station. In one aspect, the receiving station may be integrated into the dynamic fluid application controller 60; in another aspect, the receiving station may be a localized access point or a cellular base station that is configured to relay the data from the soil sensor to the dynamic fluid application controller 60. Each of the soil sensors is at least configured to report a moisture level of the soil substrate in the vicinity of the reporting soil sensor; in other aspects, each soil sensor may also be configured to report its geographic position (i.e., latitude and longitude), and its elevation.

Soil moisture data, provided by the one or more soil sensors of the environment 58 is used by the dynamic fluid application controller 60 to make fluid application decisions and to verify forecasted fluid application estimates. In one illustrative hypothetical, when the irrigation system 10 is in the vicinity of the first area 68, the dynamic fluid application controller 60 may estimate that 1 inch of fluid has been applied to the soil substrate based on one or more integrated sensors. Information from the first soil sensor 66 may verify that a moisture level of the first area 68 has increased by an amount that correlates with one inch of fluid application, verifying the estimated application data of the dynamic fluid application controller 60’s integrated sensors. In other embodiments, information from the one or more soil sensors may be extrapolated or interpolated to other areas of a soil substrate in order to improve overall fluid application estimations. In one non-limiting example, soil moisture observed in the first area 68 can be extrapolated to a fifth area 70 based at least in part on the first area 68 having an elevation within a threshold of an elevation of the fifth area 70. If, due to wind drift, evaporation, crop density, crop height, and the like, observed fluid application at the first area 68 is measured to be half of what is estimated by the integrated sensors of the dynamic fluid application controller 60, then the dynamic fluid application controller 60 can utilize the discrepancy to operate sprinklers for twice the amount of time in both the first area 68 and the fifth area 70. Similarly, moisture observations from the second soil sensor 72 can be extrapolated a sixth area 76, wherein the sixth area has an elevation within a threshold of an elevation of the second area 74. In another non-limiting example, actual fluid application rates may be interpolated using neighboring sensor data; that is, fluid application estimates in a seventh area 86 based on integrated sensors can be verified or adjusted based on interpolating soil moisture observations from the third area 80 and the fourth area 82.

Aside from soil sensors, external sensor data usable by the dynamic fluid application controller 60 in the environment 58 may be provided by an airborne platform. Multispectral, optical, or infrared imaging on an airborne platform such as an aircraft 88 (e.g., an unmanned aerial vehicle) or a satellite 90 can be used to detect soil moisture across larger fields by capturing moisture variation across a landscape after a fluid is applied.

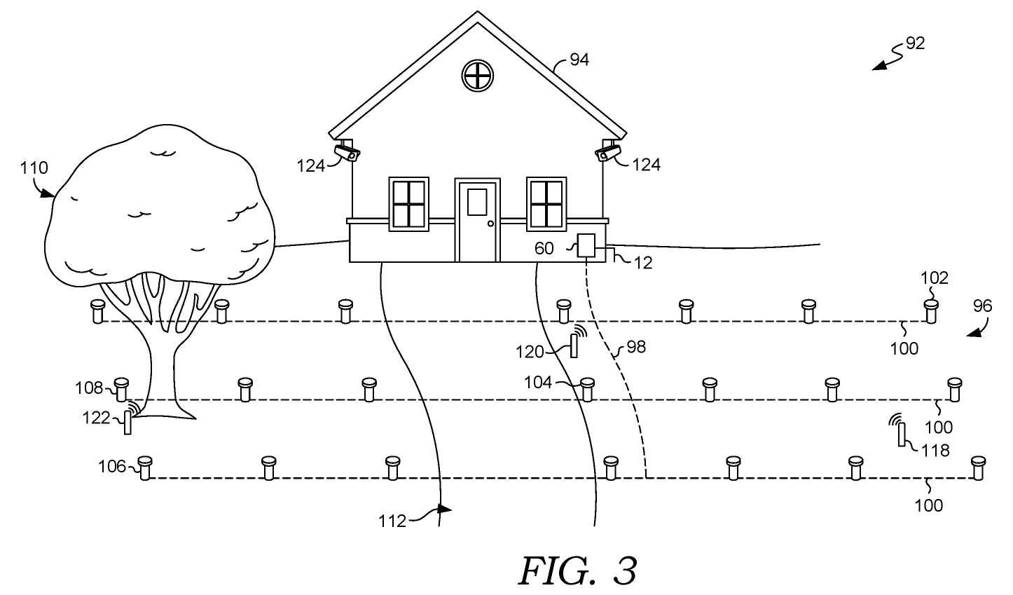

Turning now to FIG. 3, an environment 92 illustrates a residential use case in which the dynamic fluid application controller 60 may be utilized. Owing to obstacles such as a house 94, heat-absorbing features like a driveway 112, or water-absorbing features like a tree 110, moisture levels of a soil substrate of the environment 92 may vary on a smaller scale similar to moisture level variations in larger agricultural use cases. In the use case illustrated by the environment 92, the dynamic fluid application controller 60 is used to control a residential irrigation system 96 (e.g., an in-ground irrigation system). Said residential irrigation system 96 may comprise a trunk line 98 and one or more lateral lines 100, wherein the trunk link 98 and/or the one or more lateral lines 100 comprise one or more sprinklers.

As in the environment 58 of FIG. 2, the environment 92 may utilize one or more soil sensors, such as a first soil sensor 118, a second soil sensor 120, and a third soil sensor 122 to provide observed fluid application information to the dynamic fluid application controller 60 – which can corroborate the one or more integrated sensors of the dynamic fluid application controller 60 or other external sensors (e.g., an imaging system 124). In one embodiment, a single dynamic fluid application controller 60 could control operation of the irrigation system 96 by ensuring an average, minimum, or maximum observed fluid application rate verified with the estimated fluid application rate. In other words, if the desired amount of fluid application is ½ inch of water and the third soil sensor 122 is observing less actual fluid application than each of the first soil sensor 110 and the second soil sensor 120, then the irrigation system 96 could remain activated until the third soil sensor 122 observes a moisture level that correlates to a ½ inch of applied water (i.e., minimum), until the average observed moisture level of all three soil sensors correlates to a ½ inch of applied water (i.e., average), or until any observed moisture level of any of the three sensors correlates to a ½ inch of applied water (i.e., maximum).

In another embodiment, each sprinkler may be independently controlled (or controlled in clusters/groups). In such an embodiment, a single dynamic fluid application controller 60 could be used to operate a flow/cutoff valve at each of a plurality of sprinklers (e.g., using a wireless communication signal or a wired connection), or each sprinkler (or cluster of sprinklers) may have its own dynamic fluid application controller 60. For example, by controlling a first sprinkler 102 based on observed fluid application by the first sensor 118, a second sprinkler 104 based on observed fluid application by the second sensor 120, and a cluster of sprinklers (comprising a third sprinkler 106 and a fourth sprinkler 108) based on observed fluid application by the third sensor 122, soil moisture levels of the environment 92 may be much more uniform.

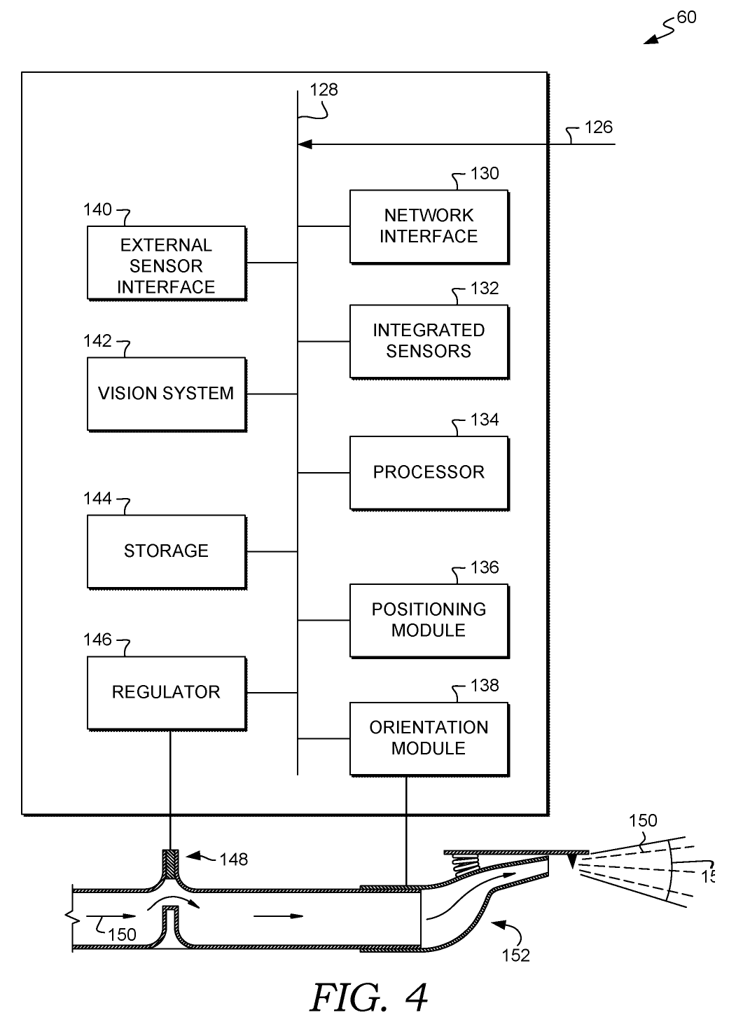

Turning now to FIG. 4, a block diagram of the dynamic fluid application controller 60 of FIGS. 2-3 is provided. The dynamic fluid application controller 60 comprises a plurality of sub-components that work cooperatively in order to control the application of a fluid (e.g., water, fertilizer, pesticide, or herbicide) to vegetation or a soil substrate. Though illustrated as separate sub-components, it is expressly conceived that more or fewer sub-components may be present that are illustrated and discussed herein. Further, though illustrated as integrated with a fluid supply and sprinkler, it is expressly conceived that the dynamic fluid application controller 60 could be an in-line component, removably coupled on an input end to a water supply, and removably coupled on an output end to a sprinkler, using an integrated valve system to control liquid flow to the output end. In yet other embodiments, one or more sprinklers could be integrated with the dynamic fluid application controller 60 and a water supply may be removably coupled to the input end.

The dynamic fluid application controller 60 comprises a power source 126. The power source 126 may take the form of a metered or external power supply (i.e., from a utility provider) or an integrated power supply. In a first aspect, the integrated power supply may take the form of a photovoltaic system (with or without an integrated battery). In other aspects, the integrated power supply may generate power by liquid moving through an irrigation system at least partially controlled by the dynamic fluid application controller 60. In such an aspect, a water wheel or micro-turbine may be spun by liquid moving through the irrigation system, and the spinning action may be used to induce voltage that can be used as a power supply (with or without an integrated battery). The dynamic fluid application controller 60 comprises a bus 128 that directly or indirectly couples sub-components of the dynamic fluid application controller 60 and provides power thereto.

The dynamic fluid application controller 60 may comprise at least one of a network interface 130 and an external sensor interface 140 for communicating externally. Either or both of the network interface 130 and the external sensor interface 140 may be wired or wireless, and may utilize any communication protocol (e.g., TCP/IP, 4G, 5G, 6G, 802.11x, Bluetooth, and the like). The network interface 130 may receive external communications from non-sensor devices or destinations, such as activation or operation information from an operator’s wireless user device (e.g., cell phone). The network interface 130 may also be used to receive external data that can be used by the dynamic fluid application controller 60 to make operational decisions, such as weather forecast data. The network interface 130 may also be used to indirectly receive external sensor data via an intermediary data/transport network, such as satellite imaging data, which can be used to verify fluid application estimates made by one or more integrated sensors 132. The external sensor interface 140 is configured to directly receive data from external sensors such as wireless soil sensors, which may be used to verify fluid application estimates made by the one or more integrated sensors 132.

The dynamic fluid application controller 60 comprises one or more integrated sensors 132. The one or more integrated sensors 132 comprises one or more of a flow meter and a timer which can be used to estimate the amount of fluid emitted by a sprinkler that is controlled by the dynamic fluid application controller 60. For example, if the dynamic fluid application controller 60 is targeting a water application of 1 inch at a particular location and time, then the one or more integrated sensors 132 may be used to determine when an amount of water equivalent to 1 inch of surface water has passed through an irrigation system to said sprinkler. The one or more integrated sensors 132 may also comprise a distance-measuring component that is configured to measure the distance between a sprinkler and vegetation (or the soil substrate). In some aspects, the one or more integrated sensors may additionally comprise one or more sensors that monitor various weather conditions. A thermometer may be used to measure the air temperature. A hygrometer may be used to measure relative humidity. A barometer may be used to measure and tracks atmospheric pressure changes. An anemometer and wind vane may be used to measure measures wind speed and direction. A rain gauge may be used to measure the amount of rainfall over a specific period. A solar radiation sensor may be used to measure the intensity of sunlight, which can be used alone or in coordination with other sensor data (e.g., temperature and relative humidity) to estimate the extent to which applied fluid is not absorbed into the soil substrate due to evaporation.

The dynamic fluid application controller 60 may comprise a vision system 142 in order to determine or estimate an amount of fluid applied to a particular area. The vision system 142 comprises one or more optical sensors that are configured to measure or detect light or electromagnetic waves that are correlated with the presence of a liquid (e.g., a stream of emitted liquid or an amount of liquid on a soil substrate or vegetation). The one or more optical sensors may comprise an infrared sensor to measure infrared radiation reflected or emitted by areas in which an applied liquid is present, a near-infrared reflectance sensor configured to measure the absorption of near infrared light that is strongly associated with water-based liquids, a hyperspectral imaging sensor configured to detect varying wavelengths of light reflected by liquid, light detection and ranging (LiDAR) configured to measure surface reflectivity changes that can be attributed to the presence of surface liquids, and a visible light camera configured to color differences that are attributable to the presence of surface liquids.

In a first embodiment, the vision system is configured to observe a liquid stream, such as a liquid stream 150 emitted from a sprinkler 152 controlled by the dynamic fluid application controller 60. In such an embodiment, the vision system 142 can estimate the amount of water applied to a particular area of vegetation or soil substrate by observing an amount of liquid droplets that make contact with vegetation or the soil substrate, droplet size, and the like. In a second embodiment, the vision system is configured to observe or estimate an amount of liquid that has been applied to an area of vegetation or soil substrate, particularly by way of differences in electromagnetic or light reflectivity. In a non-limiting example of the second embodiment, the vision system 142 may comprise a near infrared optical sensor; based on a measurement of a first near infrared reflectivity in a first area and a second near infrared reflectivity in a second area (the second reflectivity being less than the first reflectivity), the vision system may absolutely determine that the first area is insufficiently watered or that the first area is relatively less watered than the second area.

The dynamic fluid application controller 60 comprises storage 144. The storage 144 comprises non-transitory computer readable media having instructions stored thereon that, when executed by a processor 134, cause the processor 134 to perform one or more series of operations. In a first series of operations, the processor 134 determines how to operate one or more sprinklers. In a second series of operations, the processor 134 determines when and how an irrigation system or sprinkler should be operated. The storage 144 may also be used to log and update operational data from the one or more integrated sensors 132, external sensor data from the external sensor interface 140, vision system data from the vision system 142, other external source data from the network interface 130, and correlations, relationships, and the like determined and used by the controller 134.

The dynamic fluid application controller 60 comprises positioning module 136. The positioning module 136 is configured to gather real-time position and orientation data of the dynamic fluid application controller 60. The positioning module 136 may include various sensors such as a global positioning system (GPS) receiver, accelerometers, gyroscopes, and magnetometers, which work together to determine the dynamic fluid application controller 60’s spatial coordinates and orientation relative to a predefined reference frame. The dynamic fluid application controller 60 may use the positioning module 136 to collect three-dimensional positional data (e.g., latitude, longitude, and altitude) and orientation information (e.g., pitch, yaw, and roll) to enable accurate tracking of the dynamic fluid application controller 60’s movement in real-time.

The dynamic fluid application controller 60 comprises a regulator 146 for controlling the operation of a valve 148, which is used to permit, restrict, or block the flow of water 150 to a sprinkler. The regulator 146 and valve 148 may be used with any type of sprinkler, regardless of whether the connected sprinkler has a static application pattern (e.g., a rotating sprinkler or an in-ground sprinkler) or a dynamic application pattern (e.g., a precision sprinkler such as the sprinkler 152). Upon receiving an instruction, the regulator 146 directs the valve 148 to either allow liquid to be emitted, prevent liquid from being emitted, or restrict the flow to a controlled amount. When an instruction is issued to emit liquid, the regulator 146 actuates valve 148 to fully open, enabling an unrestricted flow of the water 150 to the sprinkler 152. Conversely, when the instruction indicates that liquid should not be emitted, the regulator 146 signals valve 148 to close, preventing the water 150 from reaching the sprinkler 152. If the instruction requires flow restriction, regulator 146 adjusts the valve 148 to a partially open position, allowing only a regulated amount of water 150 to pass through to the sprinkler 152.

In embodiments, the dynamic fluid application controller 60 comprises an orientation module 138 for controlling the operation of a precision sprinkler, such as the sprinkler 152. The sprinkler 152 is capable of emitting a narrow stream of water confined to an angular spread 154 that is less than a predefined threshold, allowing for highly targeted water application. The orientation module 138 is responsible for directing the sprinkler 152 to emit the flow of water 150 toward specific targets, such as designated vegetation or soil substrates, by precisely controlling the sprinkler's orientation. The sprinkler 152 may either be mounted on a multi-axis platform or configured to move independently in three dimensions, providing flexibility in aiming. For example, the multi-axis platform may comprise a combination of rotary actuators or motors that independently control movement along the x-axis, y-axis, and z-axis, providing full three-dimensional rotational and translational positioning capabilities. The orientation module 138 receives input data, such as target coordinates, from the processor 134 and calculates the required angular adjustments for the sprinkler 152. The orientation module 138 is configured to continuously monitor the sprinkler 152’s orientation using feedback from position sensors integrated into the multi-axis platform. These sensors provide real-time data on the sprinkler's current position and orientation, which is compared to the desired target position. If any deviations are detected, the orientation module 138 automatically corrects the position by issuing new commands to the rotary actuators, thereby maintaining precise targeting. Particularly in combination with the regulator 146 and the valve 148, the orientation module 138’s control of the sprinkler 152 allows the sprinkler 152 to precisely deliver liquids to a target area – allowing for precise application of liquid to vegetation of a soil substrate in an effort to achieve uniform and ideal soil moisture.

The dynamic fluid application controller 60 comprises the processor 134, which functions as the central component of the dynamic fluid application controller 60. Generally, the processor 134 determines and executes how the connected sprinklers operate. The processor 134 receives input from various sources and manages the overall operation of the system by generating control signals that govern the operation of both the regulator 146 and the orientation module 138. For example, the processor 134 can instruct the regulator 146 to control the valve 148, regulating the flow of liquid to a sprinkler based on a predetermined liquid application rate. In more advanced configurations, the processor 134 can also control the orientation of a 3D precision sprinkler 152 through the orientation module 138, enabling the precise targeting of specific areas in three dimensions, allowing the liquid to be applied exactly where and how it is needed.

The processor 134 is designed to manage the fluid application process dynamically, taking into account various independent variables that influence the actual amount of water reaching the intended target. These variables include weather conditions such as wind drift and evaporation, which can cause water loss before it reaches the soil, as well as vegetation height, terrain variability, and vegetation growth stage, which can alter the water interception and absorption rates. For example, taller vegetation may intercept more water, preventing it from reaching the soil substrate, while plants at different growth stages may have varying water needs, impacting how much water is absorbed through their root systems. Additionally, the system must account for mechanical factors, such as clogs or obstructions in the sprinkler system, and sensor inaccuracies, particularly those from integrated sensors 132 tasked with monitoring the liquid flow rate to the sprinkler.

To address these challenges, the processor 134 utilizes data from the vision system 142 in combination with data from the external sensor interface 140 (e.g., soil moisture sensors). The vision system 142 captures real-time observational data related to the distribution/emission of liquid from one or more sprinklers, providing feedback to the processor regarding the actual liquid application rate. This vision-based feedback loop is calibrated during a training phase, where data from external soil moisture sensors and other environmental factors are used to improve the accuracy of the system’s real-time observations. The processor 134 compares the intended liquid application rate, as determined by preset system parameters and monitored by the integrated sensors, with the observed liquid application rate, as detected by the vision system 142 and corroborated by external sensor data.

Based on this comparison, the processor 134 adjusts the liquid flow and orientation of the sprinkler in real time to minimize discrepancies between the intended and observed application rates. For example, if wind drift is detected, resulting in water being dispersed outside the target area, the processor 134 may instruct the regulator 146 to increase the flow rate, emit water for a longer time, reduce mobility (e.g., move a pivot irrigation system or lateral irrigation system more slowly or keep it operating in a certain position for a longer amount of time), or adjust the orientation module 138 to use the sprinkler 152 to compensate for the drift. Additionally, the processor 134 can use artificial intelligence and machine learning (ML) algorithms to analyze patterns in the observed discrepancies. Over time, the system learns to predict how various combinations of independent variables – such as wind speed, temperature, vegetation height, and sprinkler obstructions – affect water distribution and modifies future application strategies accordingly. This continuous learning allows the processor 134 to optimize liquid application even under fluctuating environmental conditions, ensuring that the system delivers the correct amount of water to the target area.

In addition to liquid application decisions, the controller 134 may, in some embodiments, use the same data collected from sensors (including weather conditions, vegetation height, soil moisture, and sprinkler performance) to provide recommendations to the farmer on when to activate the irrigation system. Based on historical data and real-time observations from the vision system 142 and external sensors, the processor 134 may analyze current environmental conditions and compares them with the ideal irrigation schedules. The system can recommend irrigation times and amounts to an operator (i.e., farmer or homeowner) by calculating the most efficient watering periods based on the forecasted weather, the crop’s growth stage, and the liquid budget, which is a pre-programmed maximum amount of water allowed for the growing season. Additionally, actual/observed liquid application data can be compiled and reported to the operator on demand; when combined with harvest yield data, the operator or other external systems can get a much more detailed and granular understanding of how liquid application timing and operation impacts yield. In one embodiment, the operator is provided with a recommendation (e.g., by way of a communication to a user device of the operator using the network interface 130 and a communication network) about when and how they should ideally operate an irrigation system powered by the dynamic fluid application controller 60. In response to the recommendation, the operator may approve, deny, or modify the recommended application/duty cycle. This feature allows the farmer to manually intervene and decide when to activate the system, while still benefiting from advanced analytics and data-driven suggestions.

In a different embodiment, the system can operate autonomously without operator intervention. In this configuration, the processor 134 uses the same data sources to automatically control the irrigation system, dynamically adjusting the regulator 146 and orientation module 138 to ensure that water is applied efficiently and in alignment with the predetermined liquid budget. The processor monitors real-time conditions and adjusts the irrigation flow and timing to ensure that the total amount of water used does not exceed the allocated amount for the growing season. By leveraging machine learning models, the system continuously optimizes the irrigation process, accounting for changing environmental factors and learned behaviors from past watering cycles. This autonomous functionality ensures precise water management and helps conserve resources, particularly in water-limited environments, while still maintaining optimal growing conditions for the crops

In embodiments, the controller may employ various types of artificial intelligence (AI) techniques and machine learning (ML) models to perform cross-validation of sensor data and power the system’s operation. The AI system may be implemented using either supervised learning, unsupervised learning, reinforcement learning, or deep learning methods, depending on the complexity of the data, the amount of sensors/inputs, and the goals of the validation and operational processes.

For instance, in one embodiment, supervised learning techniques can be employed, where the AI model is trained on labeled historical data that correlates internal sensor outputs (representing "ideal" system conditions) with external sensor inputs (representing "observed" environmental factors). Algorithms such as random forests, support vector machines (SVMs), or gradient boosting machines (GBMs) can be utilized to predict expected external sensor readings based on internal sensor data. The model would then use real-time sensor data to identify deviations from expected conditions, flagging potential anomalies in system performance.

Alternatively, unsupervised learning models, such as k-means clustering or Gaussian Mixture Models (GMMs), may be used to detect patterns and clusters in the data without predefined labels. This approach could be particularly useful for identifying latent patterns in sensor data that are not immediately apparent through direct comparison. For example, the model may group similar environmental conditions together, helping the system detect unusual behavior based on relationships that were previously unrecognized, such as novel sensor faults, combinations of environmental conditions, plant growth phase, and the like.

In more advanced embodiments, deep learning techniques, specifically recurrent neural networks (RNNs) or long short-term memory (LSTM) networks, may be deployed to account for the temporal nature of the sensor data. These models are particularly effective at handling sequential data and could be used to learn from time-series data produced by both internal and external sensors. By learning the temporal dependencies, the AI model can predict how current discrepancies between internal and external sensor data might evolve over time, providing more accurate real-time predictions and system adjustments.

Additionally, the system could implement reinforcement learning (RL) approaches to optimize the irrigation process dynamically. In this case, the AI model acts as an agent that interacts with the irrigation environment and learns from the consequences of its actions (e.g., adjusting water distribution). The Q-learning algorithm or policy gradient methods could be employed, where the controller receives feedback (rewards or penalties) based on the system’s performance (e.g., water efficiency or crop health). Over time, the model learns to take actions that maximize uniform water application while accounting for sensor validation data and external conditions.

The AI model could also utilize ensemble learning methods, combining the predictions of several different ML algorithms (e.g., a combination of decision trees, neural networks, and logistic regression) to improve the accuracy of sensor validation and environmental condition analysis. This approach reduces the likelihood of bias in a single model and provides a more robust solution for identifying discrepancies between ideal (internal) and observed (external) data.

In aspects where multiple external sensors are used, the AI model could incorporate multivariate regression models or principal component analysis (PCA) to identify relationships between different external variables (e.g., wind speed, soil moisture, temperature) and determine how they influence the difference between internal and external sensor readings. By learning these relationships, the processor 134 can isolate the variables most likely to cause discrepancies and adjust the irrigation process accordingly.

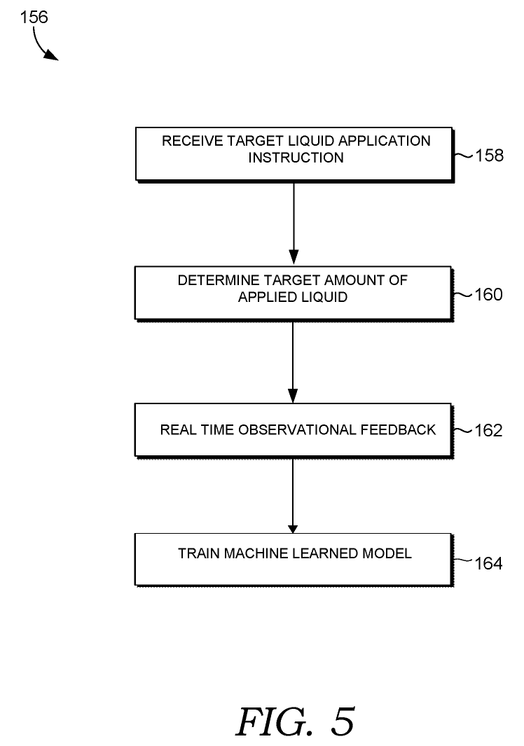

Turning now to FIG. 5, a flow diagram illustrates a method 156 for controlling a liquid application device in accordance with aspects of the present disclosure. At a first step 158, the method 156 a target liquid application instruction is received by a dynamic fluid application controller, such as the dynamic fluid application controller 60 of FIGS. 2-4. The dynamic fluid application controller may be instructed to apply a prescribed amount of liquid (e.g., one inch of water) to all portions of a geographic area (e.g., a field or lawn); in embodiments where the controller primarily controls an irrigation system, it may be instructed to increase soil moisture by a prescribed amount (e.g., increase the volumetric water content at a prescribed depth by 5%), or it may be instructed to achieve a particular soil moisture (e.g., apply water until a volumetric water content of 25% is achieved). At a second step 160, a target amount of liquid to be applied is determined in order to theoretically achieve the target liquid application instruction of step 158. At the second step 160, the dynamic fluid application controller may utilize historical data in combination with sensor data (e.g., current weather conditions, current moisture level of vegetation or a soil substrate, growth stage, and the like) to determine a liquid application plan, comprising how much liquid the controller should allow to pass through to a sprinkler or other liquid application component. In motorized irrigation systems, the liquid application plan may factor in the movement of the motorized irrigation system when determining how much liquid to apply during a time period in order to theoretically achieve the target fluid application instruction in a particular area. At a third step 162, real-time observational data is used to modify or verify the liquid application plan. Using one or more of a vision system or external sensors, such as those described with respect to FIGS. 2-4, observations of liquid application comprise feedback in a feedback used by the controller in order achieve the target liquid application instruction. In some embodiments, the method 156 comprises a fourth step 164, in which data from integrated or external sensors (e.g., weather data) is used to train a machine learned system that identifies and determines the impact of real-world conditions on liquid application, and attributing the real-world conditions to differences between the liquid application plan and liquid application observations.

In a non-limiting example of how the method 156 may be used, at the first step 158, an operator may instruct the controller to achieve a target increase in volumetric water content (VWC) of 5% at a depth of 12 inches in a cornfield. At the second step 160, the system generates a liquid application plan and determines an amount of water (e.g., 4 gallons of water per square meter) should be needed to raise the soil substrate’s VWC by 5% at the 12-inch depth. The liquid application plan may include timing for the operation of a valve; for example, in order to apply 4 gallons of water per square meter, a sprinkler should be operated for 10 minutes. As the irrigation process begins at the third step 162, the system uses observational data from a vision system and/or soil moisture sensors to monitor real-time liquid application. If the sensor data shows that the VWC increased as expected, validating the original plan, then the irrigation valve is closed after 10 minutes and the flow of water to the sprinkler stops. If, on the other hand, the observational data shows only a 3% VWC increase after 10 minutes (which could be attributable to evaporation or drift), then the system modifies the liquid application plan and allows water to flow to the sprinkler for an additional six minutes (or until the 5% target VWC increase is achieved). At the fourth step 164, independent variables, such as weather data observed by integrated weather sensors or obtained from external weather sources, is analyzed for attribution to the difference between the planned and observed liquid applications, and feedback into an algorithm (e.g., a machine-learned algorithm) for use in creating future liquid application plans.

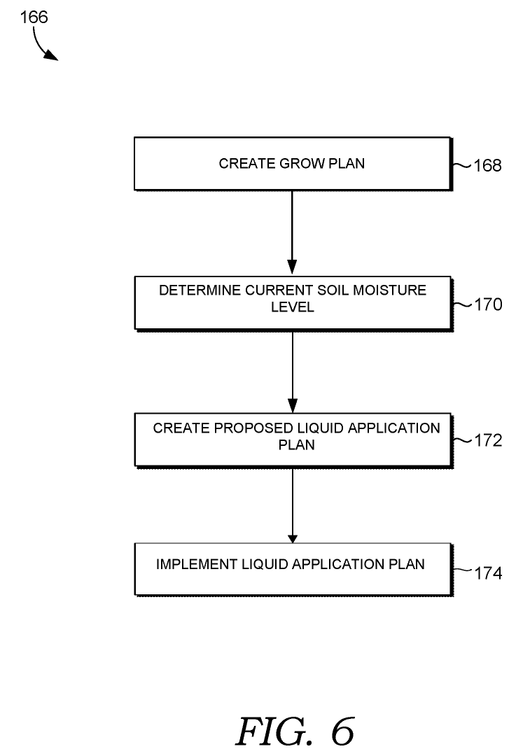

Turning now to FIG. 6, a flow diagram illustrates a method 166 for operating a liquid application device in accordance with aspects of the present disclosure described with respect to FIGS. 1-5. At a first step 168, a grow plan is created. In irrigation systems, the grow plan may factor in soil type, crop type, seasonality, and the like to determine a target moisture level or target moisture level range for an area (e.g., a cornfield). At a second step 170, it is determined that a current moisture level for the area is less than the target moisture level by greater than a predetermined threshold (e.g., any level less than the target moisture level, more than 5, 10, or 15% less than the target moisture level), or the target moisture level range. At a third step 172, a proposed liquid application plan is created in order to achieve the target moisture levels stipulated in the grow plan. In aspects, the proposed liquid application plan may take external data, such as weather forecasts, into account when determining when an irrigation system should be activated and how much water should be applied to the target area. In a first embodiment, the proposed liquid application plan is communicated to an operator’s user device; the operator may accept, deny, or modify the proposed liquid application plan and the liquid application plan is translated to irrigation control decisions and implemented at a fourth step 174. In a second embodiment, the proposed liquid application plan is automatically carried out (without intervention or approval from the operator) by translating the proposed liquid application plan into irrigation control decisions and implemented at the fourth step 174.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

What is claimed:

1. An irrigation system comprising:
a sprinkler configured to apply a fluid to a soil substrate;
a valve for regulating a fluid supply to the sprinkler;
one or more computer processing components; and
a non-transitory computer readable media with computer-executable instructions stored thereon that, when executed by the one or more computer processing components, cause the one or more computer processing components to perform operations comprising:
determining a first fluid application target rate for a first area and a second fluid application target rate for a second area, the first fluid application target rate being different than the second fluid application target rate;
determining a first amount of applied fluid at the first area and a second amount of applied fluid at the second area;
based on a determination that the first amount of applied fluid at the first area is greater than the first fluid application target rate, causing the sprinkler to stop applying the fluid in the first area; and
based on a determination that the second amount of applied fluid at the second area is less than the second fluid application target rate, causing the sprinkler to continue applying the fluid in the second area until the second amount of realized fluid application at the second area is greater than the second fluid application target rate.

2. The irrigation system of claim 1, wherein determining the first amount of applied fluid and the second amount of applied fluid is based on feedback data from an optical sensor.

3. The irrigation system of claim 2, further comprising one or more weather sensors configured to measure weather conditions.

4. The irrigation system of claim 3, wherein the one or more computer processing components are configured to perform the operations using a supervised machine learned model, and wherein the machine-learned model is trained to determine each of the first and second fluid application rates based on a dataset comprising historical weather data measured by the one or more weather sensors.

5. The irrigation system of claim 4, wherein the one or more computer processing components are further to configured to receive data from one or more soil moisture sensors, and wherein the data from the one or more soil moisture sensors is used by the machine-learned model to train the feedback data of the optical sensors.

6. The irrigation system of claim 5, further comprising a plurality of sprinklers, the plurality of sprinklers comprising a rotary sprinkler, a non-rotary sprinkler, or a precision-type sprinkler.

7. The irrigation system of claim 5, wherein the machine-learned model is further configured to generate the first fluid application target rate, the second fluid application target rate, and an operational start time based at least in part on a current moisture condition of the first area and the second area.

8. The irrigation system of claim 7, wherein the first amount of applied fluid and the second amount of applied fluid is applied by the sprinkler at the operational start time without intervention or external instructions from an operator.

9. A method for controlling operation of a liquid emitting component, the method comprising:
receiving a target liquid application instruction for a target area;
determining a target amount of a liquid to be applied to the target area by the liquid emitting component in order to achieve the target liquid application instruction;
determining an amount of time to supply the liquid to the liquid emitting component in order for the liquid emitting component to emit the target amount of the liquid;
causing the liquid to be supplied to the liquid emitting component for the amount of time; and
receiving, during the amount of time wherein liquid is supplied to the liquid emitting component, feedback from one or more sensors that indicates how much of the target amount of the liquid has been applied to the target area.

10. The method of claim 9, wherein the target liquid application instruction comprises an amount of liquid to be applied to the area.

11. The method of claim 9, wherein the target liquid application instruction comprises a target soil moisture level or a target soil moisture level range.

12. The method of claim 9, wherein the target liquid application instruction comprises a targeted increase in a soil moisture level.

13. The method of claim 9, wherein the amount of time to supply the liquid is modified based on the feedback from the one or more sensors indicating that at least a portion of the target amount of the liquid was not applied to the target area.

14. The method of claim 13, wherein the feedback from the one or more sensors comprises optical sensor data indicating how much of the target amount of the liquid was applied to the target area.

15. The method of claim 14, wherein the indication from the optical sensor data is based at least in part a machine-learned model that is trained with soil moisture sensor data.

16. The method of claim 15, wherein the machine-learned model is a supervised machine learned model, and wherein the machine-learned model is further trained to determine the target amount of the liquid to be applied to the target area based on a historical impact of weather data on historical target liquid application instructions and current weather conditions.

17. The method of claim 16, wherein the machine-learned model is further configured to generate the target liquid application instructions based on a current moisture condition of the target area, the target liquid application instructions comprising an operational start time.

18. The method of claim 17, wherein generating the target liquid application instructions is further based on a weather forecast.

19. The method of claim 18, wherein causing the liquid to be supplied to the liquid emitting component for the amount of time occurs automatically at the operational start time without intervention or external instructions from an operator.

20. A method for controlling operation of a liquid emitting component, the method comprising:
generating a grow plan for a target area, the grow plan comprising a target moisture level for the target area based on one or more of soil type, crop type, and grow season;
determining that a current moisture level for the target area is at least a predetermined threshold less than the target moisture level;
generating a proposed liquid application plan comprising an amount of liquid to be applied to the target area in order to achieve the target moisture levels stipulated in the grow plan based on historical liquid application data; and
causing the amount of liquid to be applied to the target area without intervention or external instructions from an operator.
